(19) United States
(12) Patent Application Publication
(10) Pub. No.: US 2019/0013633 A1
(43) Pub. Date: Jan. 10, 2019

(54) POWER ADAPTER AND ELECTRONIC DEVICE COMPRISING THE POWER ADAPTER

(71) Applicant: Delta Electronics (Shanghai) Co.,Ltd., Shanghai (CN)

(72) Inventors: Xiaojun CHEN, Shanghai (CN); Jinfa ZHANG, Shanghai (CN); Daofei XU, Shanghai (CN)

(21) Appl. No.: 16/013,922

(22) Filed: Jun. 20, 2018

(30) Foreign Application Priority Data
Jul. 5, 2017 (CN) 201720804759.4

(51) Int. Cl. H01R 33/94; H01R 33/06

(52) U.S. Cl. CPC H01R 33/94; H01R 2103/00; H01R 33/06

(57) ABSTRACT

The present invention discloses a power adapter and an electronic device comprising the same. The power adapter comprises a housing, which has a plurality of end faces. The power adapter further comprises a power inlet socket, which is provided on any of the plurality of end faces. The end face on which the power inlet socket is provided, at least another one of the plurality of end faces, and the power inlet socket are formed as one body integrally.

### CROSS-REFERENCE TO RELATED APPLICATIONS

This non-provisional application claims priority under 35 U.S.C. § 119(a) on Patent Application No. 201720804759.4 filed in P.R. China on Jul. 5, 2017, the entire contents of which are hereby incorporated by reference.

Some references, if any, which may include patents, patent applications and various publications, may be cited and discussed in the description of this invention. The citation and/or discussion of such references, if any, is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

### TECHNICAL FIELD

The present invention relates to a power adapter; specifically, it particularly relates to a power adapter which has reduced internal space.

### BACKGROUND ART

Nowadays, with the rapid development of science and technology, more and more miniaturized electronic devices have been developed, and power adapters are indispensable parts to many electronic devices.

At present, the power inlet sockets of the power adapters are mostly independent structures. More specifically, the power adapter needs an assembly structure to fix the power inlet socket to a housing of the power adapter, such as a card slot. Moreover, since the strength of the power adapter is required to be high, more auxiliary elements in the assembly structure is needed to meet the safety requirement. That is to say, the power adapter needs be designed to have more space in order to meet the safety requirement, and it goes against product miniaturization. Therefore, it is necessary to develop a power adapter which does not have the above-mentioned defects.

### DISCLOSURE OF THE PRESENT INVENTION

The technical problem to be solved by the present invention is to provide a power adapter comprising a housing having a plurality of end faces and a power inlet socket which is provided on any one of the plurality of end faces, wherein the end face on which the power inlet socket is provided, at least another one of the plurality of end faces, and the power inlet socket are formed as one body integrally.

The present invention further provides an electronic device, comprising:

an electronic device body;

the power adapter as described above, the power adapter being electrically connected to the electronic device body.

### BRIEF DESCRIPTION OF THE DRAWINGS

FIG. 1 is a schematic view of a first embodiment of the power adapter of the present invention;

FIG. 2 is a schematic view of a second embodiment of the power adapter of the present invention;

FIG. 3 is a schematic view of a third embodiment of the power adapter of the present invention;

FIG. 4 is a schematic view of a fourth embodiment of the power adapter of the present invention; and

FIG. 5 is a schematic view of a fifth embodiment of the power adapter of the present invention.

### EMBODIMENTS

The details and technical description of the present invention will now be further described with reference to the preferred embodiments, which, however, should not be construed as limiting the implementation of the present invention.

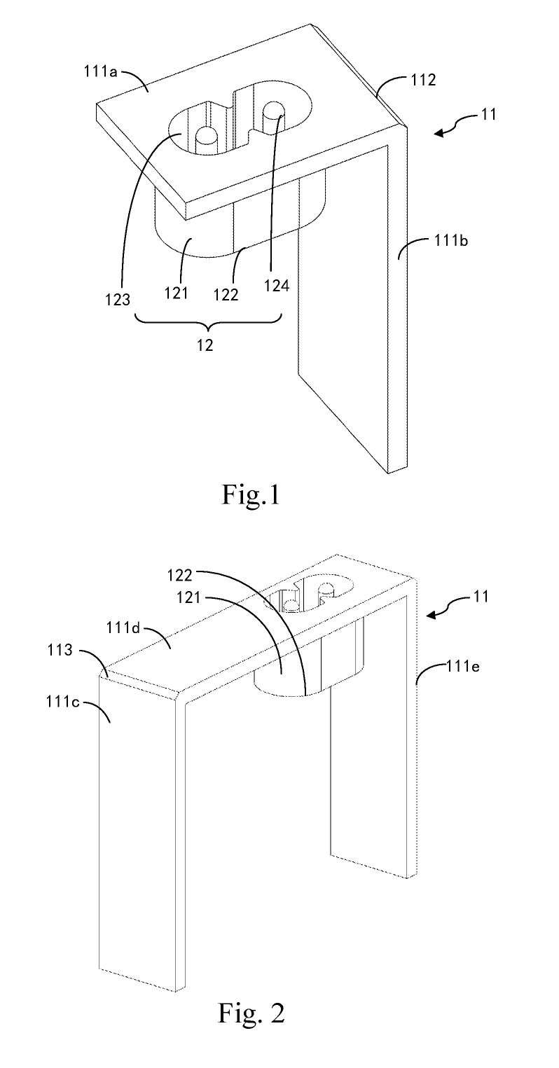

Please refer to FIG. 1, which is a schematic view of a first embodiment of the power adapter of the present invention. The power adapter of the present invention comprises a housing 11 having a plurality of end faces, though only two of the end faces are shown in FIG. 1, the present invention is not limited thereto. The power adapter further comprises a power inlet socket 12, provided on any of the plurality of end faces, and the end face on which the power inlet socket 12 is provided, at least another one of the plurality of end faces and the power inlet socket 12 are formed as one body integrally.

In the structure of the power adapter shown in FIG. 1, the plurality of end faces of the housing 11 comprise a first end face 111a and a second end face 111b which are connected in an L shape, the power inlet socket 12 is provided on the first end face 111a, and the power inlet socket 12, the first end face 111a and the second end face 111b are formed as one body integrally. But, the present invention is not limited thereto, and in other embodiments, the power inlet socket 12 may be provided on the second end face 111b.

Further, at least a portion of the first end face 111a is recessed inwardly and extends to form a side wall 121 and a bottom 122 of the power inlet socket 12, the side wall 121 and the bottom 122 form an enclosure used as a pin hole 123 for the power inlet socket 12; the power inlet socket 12 further comprises two pins 124 which are located within the pin hole 123 and are mounted on the bottom 122; however, the number of pins is not limited in the present invention, and, in some other embodiments, the power inlet socket 12 may also comprise three pins. In the present embodiment, a transition surface 112 may be further connected between the first end face 111a and the second end face 111b in order to enhance the reliability of the integrated structure. Referring to FIG. 1, the transition surface 112 is an oblique cut surface, and in other embodiments, the transition surface 112 may also be an arc surface or the like, but the present invention is not limited thereto.

Please refer to FIG. 2, which is a schematic view of a second embodiment of the power adapter of the present invention. As shown in FIG. 2, the plurality of end faces of the housing 11 comprise a first end face 111c, a second end face 111d and a third end face 111e connected in a U shape, the power inlet socket 12 is provided on the second end face 111d, and the power inlet socket 12, the first end face 111c, the second end face 111d and the third end face 111e are formed as one body integrally. It is to be noted that, in the present embodiment, the power inlet socket 12 is provided on the second end face 111d, but the present invention is not limited thereto. In other embodiments, the power inlet socket 12 may also be provided on the first end face 111c or the third end face 111e. The structure of the power inlet socket 12 is the same as that of the power inlet socket 12 shown in FIG. 1, and the details will not be described here. Further, in order to enhance the reliability of the integrated structure, a transition surface 113 is provided between the first end surface 111c and the second end surface 111d and between the second end surface 111d and the third end surface 111e, respectively. In the present embodiment, the transition surface 113 is an oblique cut surface, but the present invention is not limited thereto.

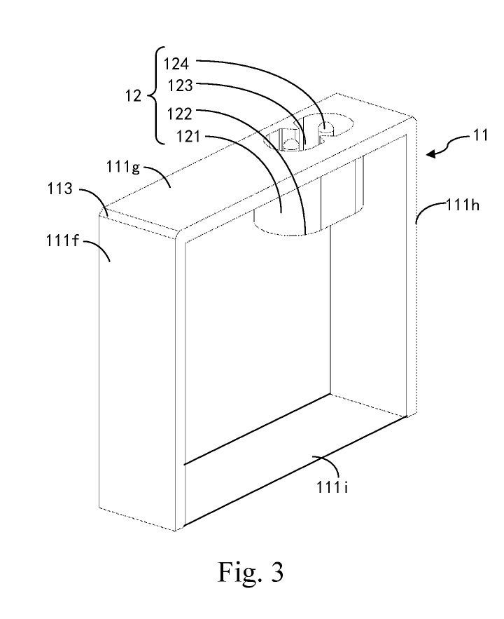

Please refer to FIG. 3, which is a schematic view of a third embodiment of the power adapter of the present invention. As shown in FIG. 3, the plurality of end faces of the housing 11 comprise a first end face 111f, a second end face 111g, a third end face 111h and a fourth end face 111i which are connected to form an enclosure structure, the power inlet socket 12 is provided on the second end face 111g, and the power inlet socket 12, the first end face 111f, the second end face 111g, the third end face 111h, and the fourth end face 111i are formed as one body integrally. It is to be noted that, in the present embodiment, the power inlet socket 12 is provided on the second end face 111g, but the present invention is not limited thereto. In other embodiments, the power inlet socket 12 may also be provided at the first end face 111f, the third end face 111h, or the fourth end face 111i. The structure of the power inlet socket 12 is the same as that of the power inlet socket 12 shown in FIG. 1, and the details will not be described here.

Further, in order to enhance the reliability of the integrated structure, a transition surface 113 is provided at the joint among the first end surface 111f, the second end surface 111g, and the third end surface 111h, wherein in the present embodiment, the transition surface 113 is an oblique cut surface.

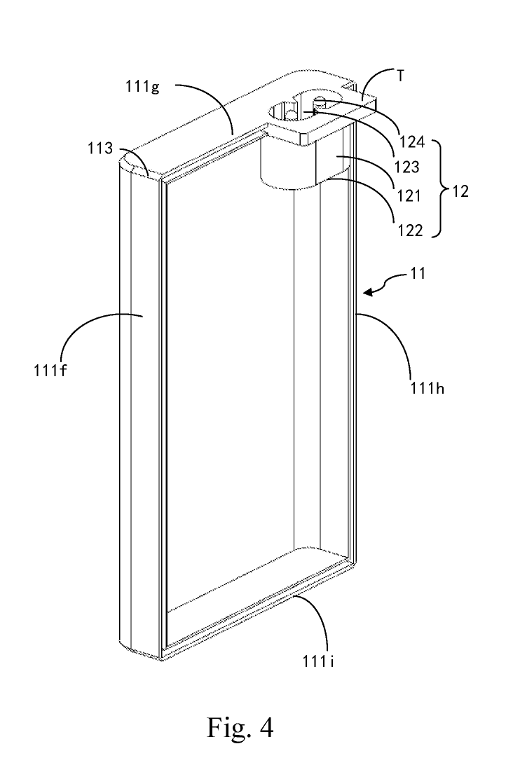

Please refer to FIG. 4, which is a schematic view of a fourth embodiment of the power adapter of the present invention. The structure of the power adapter shown in FIG. 4 is substantially the same as that of the power adapter shown in FIG. 3, and therefore the same parts will not be described here. The difference between them is set forth as follows: the second end face 111g comprise a protrusion T extending upwardly, and at least a portion of the power inlet socket 12 is provided on the protrusion T. But, the present invention is not limited thereto. In other embodiments, the protrusion T may be provided on the first end face 111f, the third end face 111h or the fourth end face 111i.

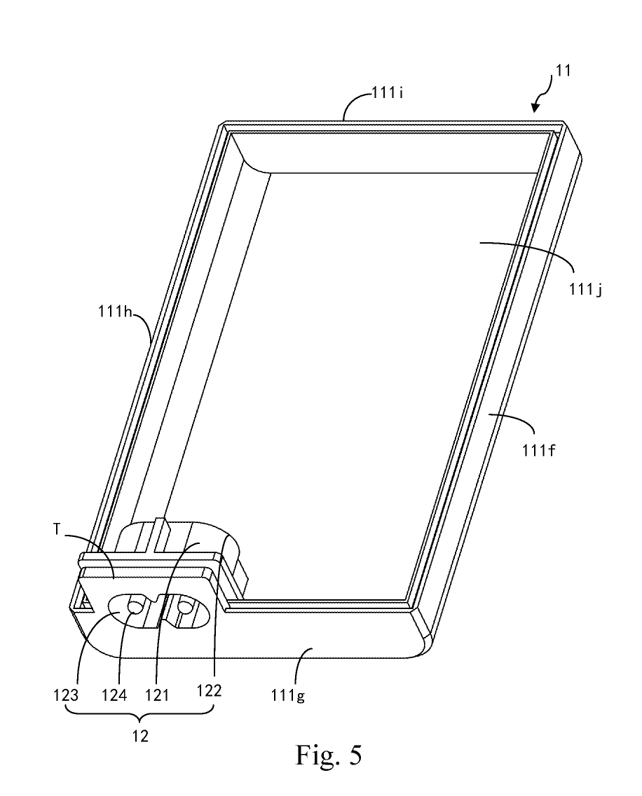

Please refer to FIG. 5, which is a schematic view of a fifth embodiment of the power adapter of the present invention. The structure of the power adapter shown in FIG. 5 is substantially the same as that of the power adapter shown in FIG. 4, and therefore the same parts will not be described here. The difference between them is set forth as follows: the plurality of end faces of the housing 11 further comprise a fifth end face 111j connected to the bottoms of the first end face 111f, the second end face 111g, the third end face 111h and the fourth end face 111i, the power inlet socket 12 is provided on the second end face 111g, and the power inlet socket 12, the first end face 111f, the second end face 111g, the third end face 111h, the fourth end face 111i, and the fifth end face 111j are formed as one body integrally. In the present embodiment, the power inlet socket 12 is provided on the second end surface 111g, but the present invention is not limited thereto. In other embodiments, the power inlet socket 12 may also be provided on the first end face 111f, the third end face 111h, the fourth end face 111i, or the fifth end face 111j. The structure of the power inlet socket 12 is the same as that of the power inlet socket 12 shown in FIG. 1, and the details will not be described here.

It is to be noted that, in the present embodiment, the fifth end face 111j is connected to the bottoms of the first end face 111f, the second end face 111g, the third end face 111h, and the fourth end face 111i. In another embodiment of the present invention, the fifth end face 111j may be connected to the tops of the first end face 111f, the second end face 111g, the third end face 111h, and the fourth end face 111i.

Further, the second end face 111g comprise a protrusion T extending upwardly, and at least a portion of the power inlet socket 12 is provided on the protrusion T. But, the present invention is not limited thereto. In other embodiments, the protrusion T may be provided on the first end face 111f, the third end face 111h, or the fourth end surface 111i.

The present invention further provides an electronic device comprising: an electronic device body and a power adapter, the power adapter being electrically connected to the electronic device body, wherein the specific structure of the power adapter is the same as that of the power adapter shown in FIGS. 1-5, and the details will not be described here.

In summary, by forming the power inlet socket and at least two end faces of the housing as one body integrally in a power adapter, the assembly structure between the power inlet socket and the housing is omitted, thereby reducing the assembly space inside the housing of the power adapter, and miniaturizing the power adapter while enhancing the reliability of the power adapter.

The above are only the preferred embodiments of the present invention and are not used to limit the scope of the present invention. Without departing from the spirit and substance of the present invention, it is appreciated that those skilled in the art can make all kinds of corresponding changes and modifications according to the present invention, but these corresponding changes and modifications all should fall within the protection scope of the claims appended to the present invention.

What is claimed is:

1. A power adapter, comprising:
a housing having a plurality of end faces; and
a power inlet socket provided on any one of the plurality of end faces;
wherein the end face on which the power inlet socket is provided, at least another one of the plurality of end faces, and the power inlet socket are formed as one body integrally.

2. The power adapter according to claim 1, wherein the plurality of end faces comprise a first end face and a second end face connected in an L shape, the power inlet socket is provided on the first or second end face; and
wherein the power inlet socket, the first end face and the second end face are formed as one body integrally.

3. The power adapter according to claim 1, wherein the plurality of end faces comprise a first end face, a second end face and a third end face connected in a U shape, the power inlet socket is provided on the first, second or third end face; and
wherein the power inlet socket, the first end face, the second end face and the third end face are formed as one body integrally.

4. The power adapter according to claim 1, wherein the plurality of end faces comprise a first end face, a second end face, a third end face and a fourth end face connected to form an enclosure structure, the power inlet socket is provided on the first, second, third or fourth end face; and
wherein the power inlet socket, the first end face, the second end face, the third end face and the fourth end face are formed as one body integrally.

5. The power adapter according to claim 4, wherein the plurality of end faces further comprise a fifth end face, which is connected to top or bottom of the enclosure structure; and
wherein the power inlet socket, the first end face, the second end face, the third end face, the fourth end face and the fifth end face are formed as one body integrally.

6. The power adapter according to claim 1, wherein at least a portion of the end face on which the power inlet socket is provided is recessed and extends to form side walls and bottom surface of the power inlet socket, and the side walls and the bottom surface form an enclosure used as a pin hole for the power inlet socket.

7. The power adapter according to claim 2, wherein at least a portion of the end face on which the power inlet socket is provided is recessed and extends to form side walls and bottom surface of the power inlet socket, and the side walls and the bottom surface form an enclosure used as a pin hole for the power inlet socket.

8. The power adapter according to claim 6, wherein the power inlet socket further comprises two or three pins located within the pin hole and mounted on the bottom.

9. The power adapter according to claim 7, wherein the power inlet socket further comprises two or three pins located within the pin hole and mounted on the bottom.

10. The power adapter according to claim 1, wherein the end face on which the power inlet socket is provided comprises a protrusion, on which at least a portion of the power inlet socket is disposed.

11. An electronic device, comprising:
an electronic device body; and
a power adapter electrically connected to the electronic device body, the power adapter comprises:
a housing having a plurality of end faces; and
a power inlet socket provided on any one of the plurality of end faces;
wherein the end face on which the power inlet socket is provided, at least another one of the plurality of end faces, and the power inlet socket are formed as one body integrally.

12. The electronic device according to claim 11, wherein the plurality of end faces comprise a first end face and a second end face connected in an L shape, the power inlet socket is provided on the first or second end face; and
wherein the power inlet socket, the first end face and the second end face are formed as one body integrally.

13. The electronic device according to claim 11, wherein the plurality of end faces comprise a first end face, a second end face and a third end face connected in a U shape, the power inlet socket is provided on the first, second or third end face; and
wherein the power inlet socket, the first end face, the second end face and the third end face are formed as one body integrally.

14. The electronic device according to claim 11, wherein the plurality of end faces comprise a first end face, a second end face, a third end face and a fourth end face connected to form an enclosure structure, the power inlet socket is provided on the first, second, third or fourth end face; and
wherein the power inlet socket, the first end face, the second end face, the third end face and the fourth end face are formed as one body integrally.

15. The electronic device according to claim 14, wherein the plurality of end faces further comprise a fifth end face, which is connected to top or bottom of the enclosure structure; and
wherein the power inlet socket, the first end face, the second end face, the third end face, the fourth end face and the fifth end face are formed as one body integrally.

16. The electronic device according to claim 11, wherein at least a portion of the end face on which the power inlet socket is provided is recessed and extends to form side walls and bottom surface of the power inlet socket, and the side walls and the bottom surface form an enclosure used as a pin hole for the power inlet socket.

17. The electronic device according to claim 12, wherein at least a portion of the end face on which the power inlet socket is provided is recessed and extends to form side walls and bottom surface of the power inlet socket, and the side walls and the bottom surface form an enclosure used as a pin hole for the power inlet socket.

18. The electronic device according to claim 16, wherein the power inlet socket further comprises two or three pins located within the pin hole and mounted on the bottom.

19. The electronic device according to claim 17, wherein the power inlet socket further comprises two or three pins located within the pin hole and mounted on the bottom.

20. The electronic device according to claim 11, wherein the end face on which the power inlet socket is provided comprises a protrusion, on which at least a portion of the power inlet socket is disposed.
